(19) United States
(12) Patent Application Publication
(10) Pub. No.: US 2026/0095655 A1
(43) Pub. Date: Apr. 2, 2026

(54) LENS APPARATUS, IMAGE PICKUP APPARATUS, AND IMAGING SYSTEM

(71) Applicant: CANON KABUSHIKI KAISHA, Tokyo (JP)

(72) Inventor: JUNICHI SUZUKI, Tochigi (JP)

(21) Appl. No.: 19/311,267

(22) Filed: Aug. 27, 2025

(30) Foreign Application Priority Data
Oct. 2, 2024 (JP) 2024-173124

(51) Int. Cl. H04N 23/68; G03B 13/18; H04N 23/66

(52) U.S. Cl. CPC H04N 23/687; G03B 13/18; H04N 23/66

(57) ABSTRACT

A lens apparatus includes an optical member movable according to control by each of a plurality of operation units, moves the optical member according to information on at least one of a target position and a speed of the optical member set by the first operation unit, and determines an operation unit which transmits a signal regarding activation and deactivation of a predetermined function at an earliest timing among the plurality of operation units, as the first operation unit. Each of the plurality of operation units includes a first operation member configured to switch the activation and the deactivation of the predetermined function, a second operation member configured to change the target position, and a third operation member configured to change the speed.

### BACKGROUND

### Field of the Technology

The aspect of the disclosure relates to one or more embodiments of a lens apparatus, an image pickup apparatus, and an imaging system for television imaging, movie imaging, and the like.

### Description of the Related Art

The conventional imaging system having a lens apparatus, a camera apparatus, an operation apparatus, and the like is operated by a plurality of operators (operation units), and achieves imaging by determining settings and operation commands (instructions) to be reflected in the lens apparatus and the camera apparatus (Japanese Patents Nos. 6410778 and 6628206).

### SUMMARY

One or more embodiments of a lens apparatus according to one or more aspects of the disclosure may include an optical member movable according to control by each of a plurality of operation units, one or more memories storing commands, and one or more processors that, upon execution of the commands, operate to determine a first operation unit for moving the optical member from the plurality of operation units, and move the optical member according to information on at least one of a target position and a speed of the optical member set by the first operation unit. The lens apparatus includes a predetermined function. The one or more processors operate to determine an operation unit which transmits a signal regarding activation and deactivation of the predetermined function at an earliest timing among the plurality of operation units, as the first operation unit. Each of the plurality of operation units includes a first operation member configured to switch the activation and the deactivation of the predetermined function, a second operation member configured to change the target position, and a third operation member configured to change the speed. One or more image pickup apparatuses and imaging systems may include one or more lens apparatuses in accordance with one or more other aspects of the disclosure.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of an imaging system according to a first embodiment (pattern 1).

FIG. 2 is a flowchart illustrating a flow of command-value adoption in the first embodiment (pattern 1).

FIG. 3 (31A, 31B, 32A, 32B, 33A, and 33B) is a schematic diagram illustrating the command-value adoption and reflection in the first embodiment (pattern 1).

FIG. 4 is a block diagram illustrating another example of the imaging system according to the first embodiment (pattern 2).

FIGS. 5A and 5B are flowcharts illustrating a flow of command-value adoption in the first embodiment (pattern 2).

FIG. 6 (61A, 61B, 62A, 62B, 63A, 63B, 64A, and 64B) is a schematic diagram illustrating the command-value adoption and reflection in the first embodiment (pattern 2).

FIG. 7 is a flowchart illustrating a flow of the command-value adoption in the first embodiment (pattern 3).

FIG. 8 is a flowchart illustrating a flow of the command-value adoption in the first embodiment (pattern 4).

FIGS. 9A and 9B (91A, 91B, 91C, 92A, 92B, 92C, 93A, 93B, 93C, 94A, 94B, and 94C) are schematic diagrams illustrating the command-value adoption and reflection in the first embodiment (pattern 4).

FIG. 10 is a block diagram illustrating an imaging system according to a second embodiment (pattern 1).

FIG. 11 is a flowchart illustrating a flow of command-value adoption in the second embodiment (pattern 1).

FIG. 12 is a flowchart illustrating a flow of the command-value adoption in the second embodiment (pattern 2).

FIG. 13 is a block diagram of an imaging system according to a third embodiment.

FIG. 14 is a flowchart illustrating a display flow of command-value information in the third embodiment.

FIGS. 15A, 15B, 15C, and FIG. 15D illustrate display examples of a command value in the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of commands, or a program that can be executed by a programmable processor such as a microprocessor, a central processing unit (CPU), or a specially designed programmable device or controller. A memory contains commands or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

Some lens apparatuses have a function for gradually blurring an object from an in-focus state (blurring effect activated (turned on) hereinafter) as an image effect (there is also an opposite function; blurring effect deactivated (turned off) hereinafter). Some lens apparatuses have a configuration for driving a back-focus lens that is more sensitive than a focus lens, and in either case, these lens apparatuses can achieve imaging in a state in which an object is intentionally out of focus, or in a state in which the object gradually approaches an in-focus state from the out-of-focus (defocus) state. The blurring effect requires three operations: an operation for activating/deactivating (enabling/disabling or turning de) a deblurring function, an operation for a blurring amount, an operation for a blurring speed or a deblurring speed (speed at which a deblurred image is returned to the original state), and thus there are many types of operations (operation members). In addition, the blurring effect uses an image during operation, so the image during operation is important. Another feature of this function is that a deactivated operation is also important.

Thus, in a function that has a plurality of operation members such as not only activation/deactivation but also position and speed, the conventional method may reflect unintentional operations or make the operation complicated. The function using an image during operation, such as a blurring effect, may cause an unintentional image to be used or an intended image may be missed. The problems in the imaging system having a plurality of operators are very significant. Therefore, even with a function that has many operation members and is operated by a plurality of operators, the operation unit may be smoothly switched and the command value may be reflected with simple operations.

In this embodiment, the disclosure is applied to the blurring effect described above, but this embodiment is not limited to this example. The disclosure is applicable to a predetermined function provided by the lens apparatus.

### First Embodiment

### PATTERN 1

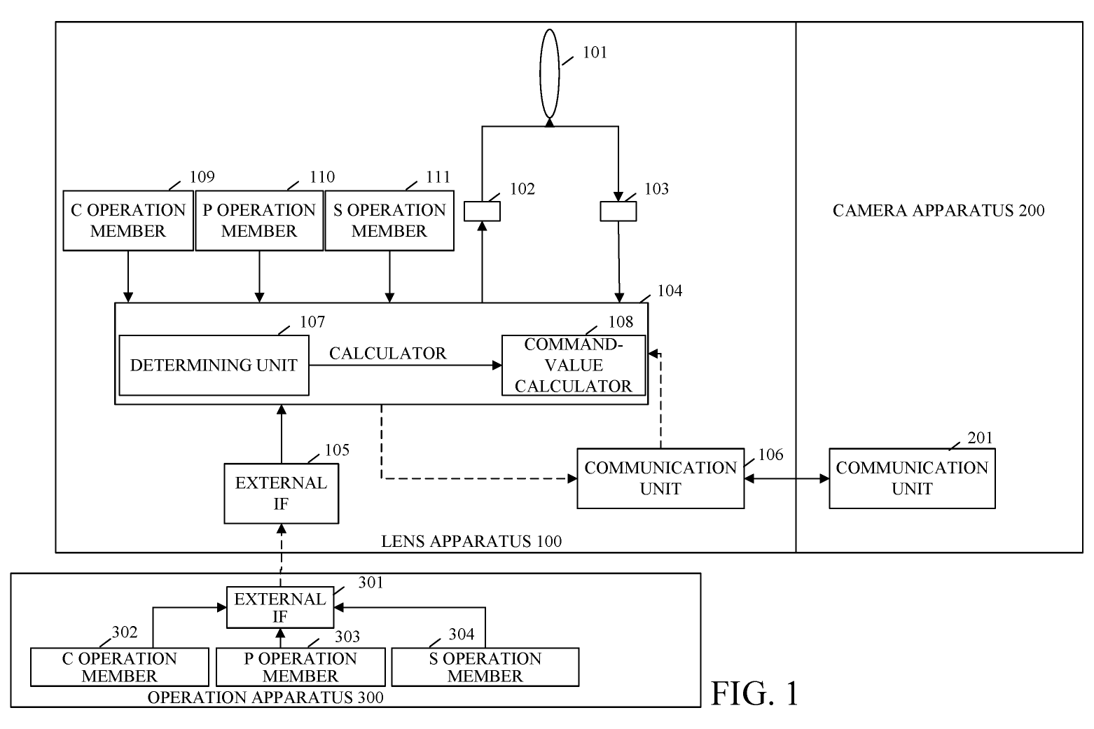

FIG. 1 is a block diagram illustrating an example of an imaging system according to a first embodiment. The imaging system includes a lens apparatus 100, a camera apparatus 200, and an operation apparatus 300.

First, the lens apparatus 100 will be described. The lens apparatus 100 includes a back-focus lens 101, a back-focus lens drive unit 102, a back-focus lens position detector 103, a calculator 104, an external interface (IF) 105, and a communication unit 106. The lens apparatus 100 further includes a lens operation unit including a C operation member 109, a P operation member 110, and an S operation member 111. The lens apparatus 100 further includes optical members (optical elements) such as a zoom lens, a focus lens, and an aperture stop (not illustrated).

The back-focus lens 101 is a lens unit that is movable along the optical axis to adjust the back focus of the lens apparatus 100, and is a lens with higher sensitivity than that of a focus lens. In this embodiment, the back-focus lens 101 is also movable in a case where the blurring effect is turned on and off. As will be described later, the blurring effect is operable from a plurality of operation units (operators) other than the lens operation unit.

The back-focus lens drive unit 102 is an actuator for moving the back-focus lens 101. In this embodiment, it is a DC motor but is not limited to this example.

The back-focus lens position detector 103 is a position sensor configured to detect the position of the back-focus lens 101. In this embodiment, it is an encoder, but is not limited to this example.

The calculator 104 is a CPU and includes a determining unit 107 and a command-value calculator 108. In a case where a command to move the back-focus lens 101 is input, the determining unit 107 determines which operation unit (first operation unit) drives the back-focus lens 101 and adopts a command value. The command-value calculator 108 calculates a drive signal based on the operation unit and command value determined by the determining unit 107 and the position information from the back-focus lens position detector 103, and outputs a calculated drive signal to the back-focus lens drive unit 102. The calculator 104 also processes a request from the camera apparatus 200 according to an input from the communication unit 106, calculates information to be sent back to the camera apparatus 200, and outputs it to the communication unit 106.

The external IF 105 is an IF that can be connected to an external apparatus and can input and output voltages and signals. In this embodiment, it is a connection IF with the operation apparatus 300. The voltage and signal information input from the operation apparatus 300 are input into the calculator 104, and the output voltage and signal information generated by the calculator 104 are output to the operation apparatus 300.

The communication unit 106 communicates with the camera apparatus 200. In a case where it receives a command or request from the camera apparatus 200, it outputs the received command or request to the calculator 104. In a case where it receives information from the calculator 104 according to a command or request from the camera apparatus 200, it transmits the input information to the camera apparatus 200.

The lens operation unit is an operation unit for controlling the blurring effect.

The C operation member 109 is an operation member for switching the activation (enabling or turning on) and deactivation (disabling or turning off) of the blurring effect. In this embodiment, it is a toggle-type switch but is not limited to this example. A signal switched by the switch is input into the calculator 104 as a blurring effect activation/deactivation command (sometimes referred to as a blurring effect on/off command).

The P operation member 110 is an operation member for changing a blurring amount of the blurring effect (for changing the target position of the back-focus lens 101). In this embodiment, it is a rotary type volume switch but is not limited to this example. A signal that changes with a volume switch is input into the calculator 104 as a blurring effect position command.

The S operation member 111 is an operation member for changing the speed of the back-focus lens 101 (for changing the speed of the back-focus lens 101). In this embodiment, it is a rotary type volume switch but is not limited to this example. A signal that changes with the volume switch is input into the calculator 104 as a blurring effect speed command.

Next, the camera apparatus 200 will be described. The camera apparatus 200 is an image pickup apparatus communicably connected to the lens apparatus 100. The camera apparatus 200 includes an image sensor (not illustrated) and a communication unit 201, and transmits a request to the lens apparatus 100 and receives information about the lens apparatus 100 through communication.

Next, the operation apparatus 300 will be described. The operation apparatus 300 is an operation unit connected to the lens apparatus 100 and configured to operate the blurring effect. The operation apparatus 300 includes an external IF 301, a C operation member 302, a P operation member 303, and an S operation member 304.

The external IF 301 is an IF connected to the lens apparatus 100 and configured to input and output voltages and signals. It outputs output voltages and signal information generated within the operation apparatus 300 to the lens apparatus 100.

The C operation member 302 is an operation member for switching the activation (enabling or turning on) and deactivation (disabling or turning off) of the blurring effect. In this embodiment, it is a toggle type switch, but is not limited to this example. A signal switched by the switch is input into the lens apparatus 100 via the external IF 301 as a blurring effect on/off command.

The P operation member 303 is an operation member for changing a blurring amount of the blurring effect. In this embodiment, it is a rotary type volume switch but is not limited to this example. A signal that changes with the volume switch is input into the lens apparatus 100 via the external IF 301 as a blurring effect position command.

The S operation member 304 is an operation member for changing the speed of the lens driven by the blurring effect. In this embodiment, a rotary type volume switch is used, but this is not limited to this example. A signal that changes with the volume switch is input into the lens apparatus 100 via the external IF 301 as a blurring effect speed command.

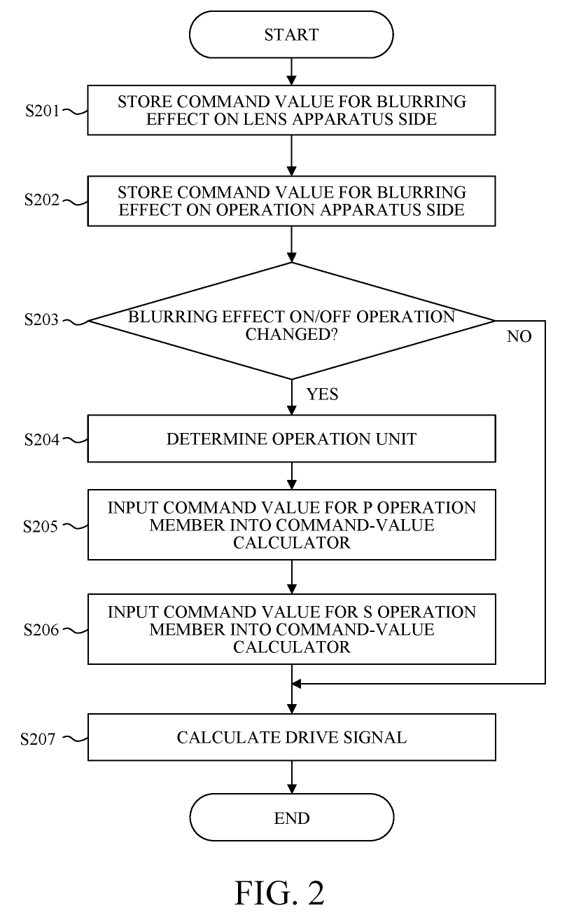

Next follows a description of the processing of selecting an operation unit for controlling the blurring effect and determining the command value to be adopted. FIG. 2 is a flowchart illustrating a flow of command-value adoption in this embodiment.

In step S201, the calculator 104 stores the input values of the C operation member 109, the P operation member 110, and the S operation member 111 as the command value for the blurring effect on the lens apparatus 100 side.

In step S202, the calculator 104 stores the input values of the C operation member 302, the P operation member 303, and the S operation member 304 as command values for the blurring effect on the operation apparatus 300 side.

In step S203, the determining unit 107 determines whether or not there has been a change in the blurring effect activation/deactivation (on/off) operation based on the changes in the command value of the C operation member 109 stored in step S201 and the command value of the C operation member 302 stored in step S202. In a case where the lens apparatus 100 determines that there has been a change, it executes the processing of step S204, and in a case where it determines that there has not been a change, it executes the processing of step S207.

In step S204, the determining unit 107 determines an operation unit and a command value to be adopted. More specifically, the determining unit 107 determines the operation unit determined in step S203 as having "changed" as an operation unit for controlling the blurring effect, and adopts the command value from the determined operation unit. If a change is detected simultaneously, this embodiment adopts a command value of the operation apparatus 300 side, but is not limited to this example. For example, the command value on the lens apparatus 100 side may be adopted, or it may be determined by settings. This processing is performed for each processing sampling of the CPU, and since it is rare that one command value is not adopted forever by detecting a change simultaneously every time, it is not taken into consideration. In this embodiment, the following description will be given assuming that there has been a change on the operation apparatus 300 side.

In step S205, the determining unit 107 inputs the command value of the P operation member determined in step S204 into the command-value calculator 108.

In step S206, the determining unit 107 inputs the command value of the S operation member determined in step S204 into the command-value calculator 108.

In step S207, the command-value calculator 108 calculates a drive signal for driving the back-focus lens 101 based on the input command values of the C operation member, the P operation member, and the S operation member.

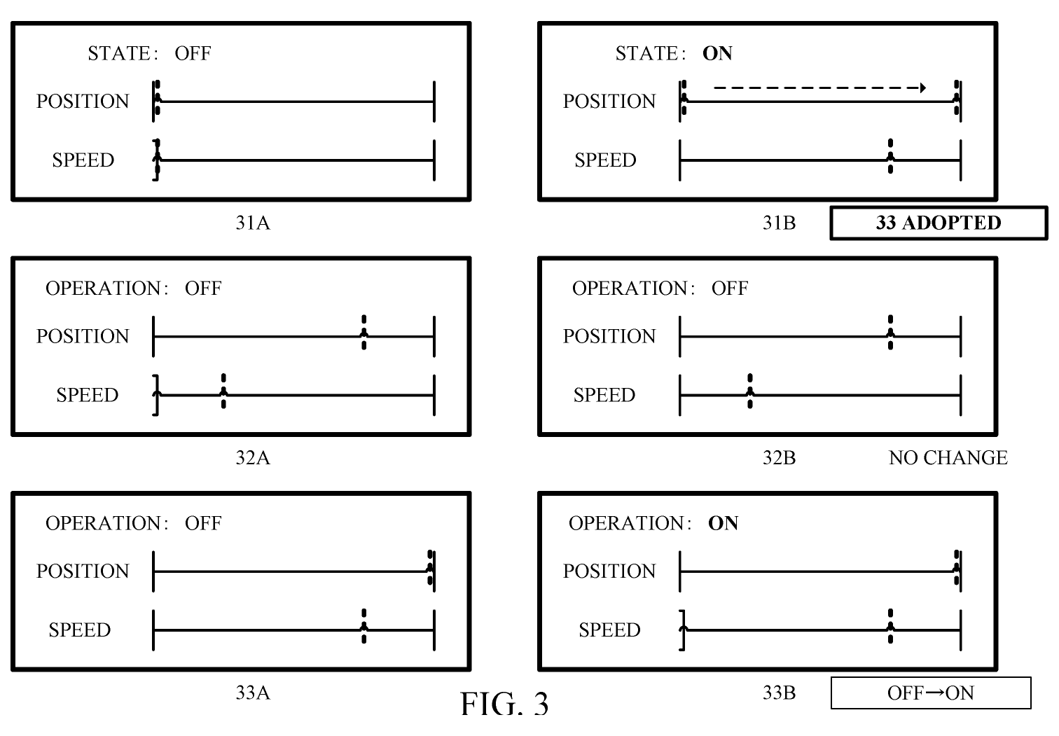

Referring now to FIG. 3 (31A, 31B, 32A, 32B, 33A, and 33B), a description will be given of changes in the position and speed of the back-focus lens due to the determination of the command value to be adopted. FIG. 3 (31A, 31B, 32A, 32B, 33A, and 33B) is a schematic diagram illustrating the command-value adoption and reflection.

31A and 31B in FIG. 3 illustrate a blurring effect on/off state and the position and speed of the back-focus lens 101. 32A and 32B in FIG. 3 illustrate the state of the command value of the lens operation unit of the lens apparatus 100. "Operation" is input from the C operation member 109, "position" from the P operation member 110, and "speed" from the S operation member 111. 33A and 33B in FIG. 3 illustrate the state of the command value of the operation apparatus 300. "Operation" is input from the C operation member 302, "position" from the P operation member 303, and "speed" from the S operation member 304. A and B in FIG. 3 illustrate at different times, where each A illustrates a state at a certain time, and each B illustrates a state at a certain time that is more recent than that of A.

At the time of 31A in FIG. 3, the blurring effect is turned off and the back-focus lens 101 is stopped at an end position. In a case where an operation to turn on the blurring effect is performed from the operation apparatus 300 at time B, for example as illustrated in 33B in FIG. 3, the command of the operation apparatus 300 is adopted according to the flow illustrated in FIG. 2. As a result, the blurring effect is turned on, and the back-focus lens 101 is driven to a designated target position at a designated speed according to the command of the operation apparatus 300.

At this time, in a case where the P operation member 303 in the operation apparatus 300 is operated, the back-focus lens 101 is driven according to the operation. However, the lens apparatus 100 behaves in such a way that the back-focus lens 101 is not driven even if the P operation member 110 is operated unless the C operation member 109 is operated.

The above configuration gives priority to the operation after the activation/deactivation operation (the operation at the timing closest to the present or at the earliest timing), and can adopt the operation intended by the user in a function in which a plurality of operators have a plurality of operation members.

### PATTERN 2

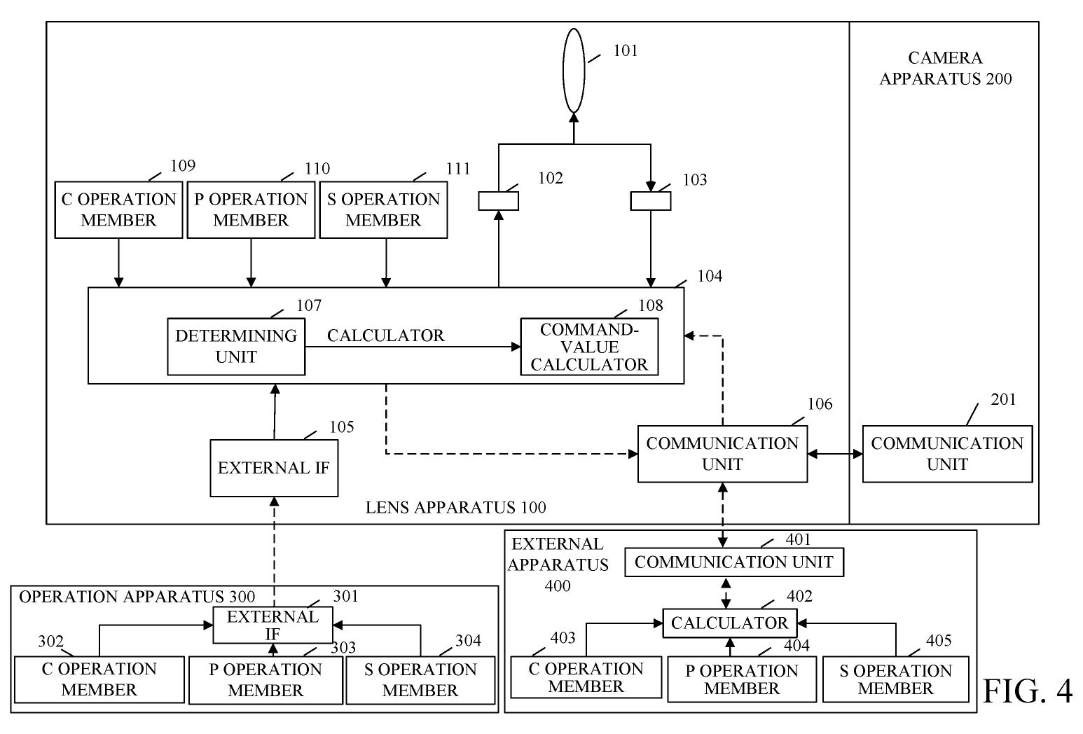

As described below, there are situations in which it is better not to change the operation unit (not to accept operations from other operation units). For example, in an imaging system in which a plurality of operators, including an operator remote from the camera operator, can operate the blurring effect, the camera operator may accidentally turn on and off the blurring effect while a remote operator is operating the blurring effect. In this case, since it affects the captured image, a measure to avoid this may be provided. An example will be described below with reference to 61A, 61B, 62A, 62B, 63A, 63B, 64A, and 64B in FIGS. 4 to 6. Those elements, which are corresponding elements in Pattern 1, will be designated by the same reference numerals and a description thereof will be omitted.

FIG. 4 is a block diagram of another example of the imaging system according to this embodiment. The imaging system in FIG. 4 differs from the imaging system in FIG. 1 in that an external apparatus 400 is added.

The external apparatus 400 is a communication apparatus communicably connected to the lens apparatus 100 and configured to at least operate the blurring effect. The external apparatus 400 includes a communication unit 401 and a calculator 402. The external apparatus 400 further includes an external operation unit that includes a C operation member 403, a P operation member 404, and an S operation member 405.

The communication unit 401 is a communication unit that communicates with the lens apparatus 100. When it receives a command or request from the lens apparatus 100, it outputs the received command or request to the calculator 402. Conversely, when it receives information from the calculator 402 according to the command or request from the lens apparatus 100, it transmits the information that was input into the lens apparatus 100.

The calculator 402 includes a CPU. It calculates a command value based on an input from the external operation unit and outputs it to the communication unit 401. The external apparatus 400 also processes a request from the lens apparatus 100 according to input from the communication unit 401, calculates information to be sent back to the lens apparatus 100, and outputs the information to the communication unit 401.

The C operation member 403 is an operation member for switching the activation (enabling or turning on) and deactivation (disabling or turning off) of the blurring effect. In this embodiment, it is a toggle type switch, but is not limited to this example.

The P operation member 404 is an operation member for changing a blurring amount of the blurring effect. In this embodiment, it is a rotary type volume switch but is not limited to this example.

The S operation member 405 is an operation member for changing the speed of the lens driven by the blurring effect. In this embodiment, it is a rotary type volume switch but is not limited to this example.

In this embodiment, the external apparatus 400 can make an acquisition request for an operation authority of the blurring effect by some means such as an unillustrated switch. All information from the external operation unit is processed by the calculator 402 and then transmitted from the communication unit 401. However, the operation information on at least one of the external operation units may be input as a voltage value or signal information, similarly to the operation apparatus 300. In a case where the determining unit 107 receives a request for an operation authority from the external apparatus 400, it returns a signal indicating that the operation authority can be acquired (a signal indicating that the operation unit has been selected to control the blurring effect) in a case where the operation authority can be granted. In a case where the determining unit 107 transmits a signal indicating that the operation authority can be acquired, it accepts only control from the external operation unit and does not accept control from operation units other than the external operation unit.

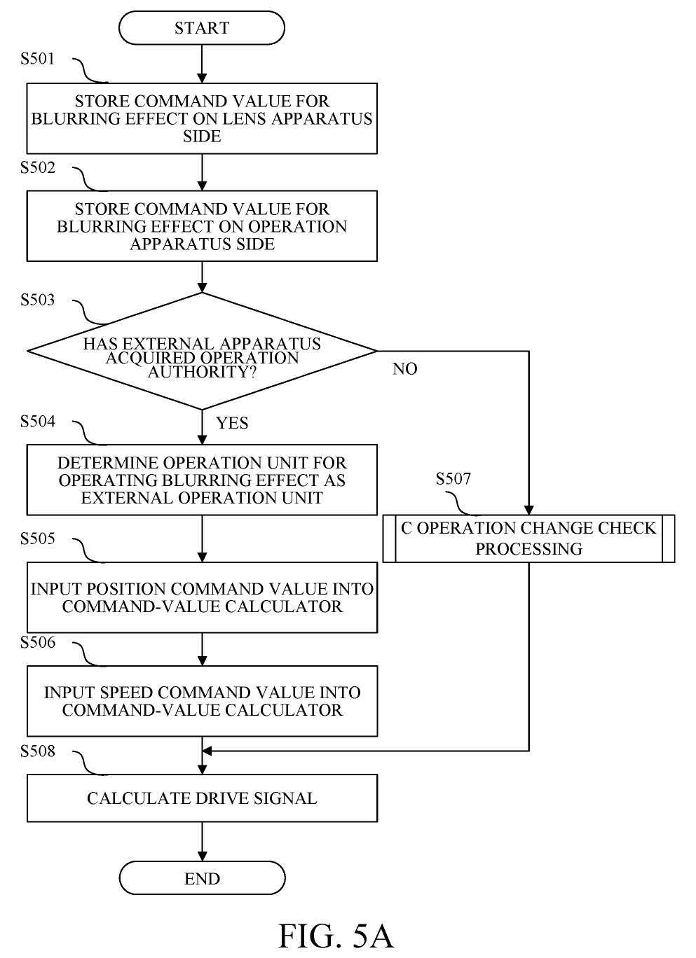

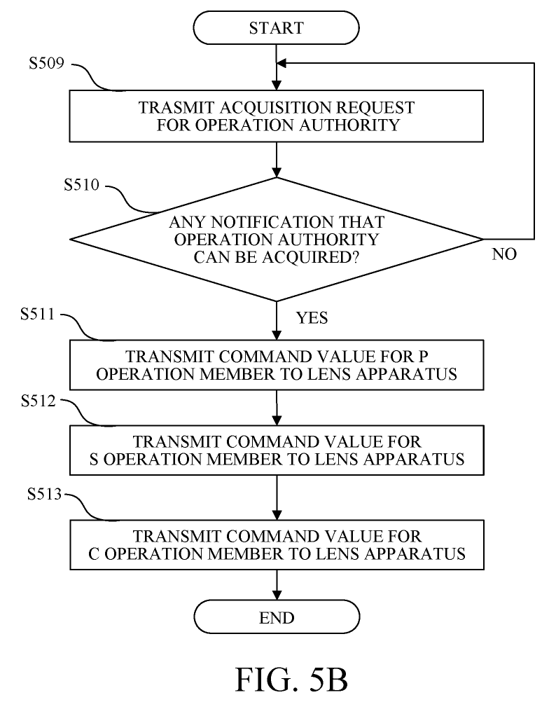

A description will now be given of the processing of selecting the operation unit for controlling the blurring effect and determining a command value to be adopted. FIGS. 5A and 5B are flowcharts illustrating a flow of command-value adoption in this embodiment. FIG. 5A illustrates the processing of the lens apparatus 100, and FIG. 5B illustrates the processing of the external apparatus 400.

First, the flow of FIG. 5A will be described.

Since the processing of steps S501 to S502 is similar to the processing of steps S201 to S202, respectively, a description thereof will be omitted.

In step S503, the determining unit 107 determines whether or not the external apparatus 400 has acquired an operation authority. In a case where the determining unit 107 determines that the operation authority for the blurring effect has been acquired, it executes the processing of step S504, and in a case where it determines that the operation authority has not been acquired, it executes the processing of step S507. Even if the external apparatus 400 has not acquired the operation authority, if an acquisition request for the operation authority has been received, the determining unit 107 returns an operation authority available to the external apparatus 400 in a case where the operation authority can be granted.

In step S504, the determining unit 107 determines that the operation unit for controlling the blurring effect is the external operation unit (external apparatus 400).

In step S505, the determining unit 107 inputs a position command value for the blurring effect received from the external apparatus 400 to the command-value calculator 108.

In step S506, the determining unit 107 inputs a speed command value for the blurring effect received from the external apparatus 400 to the command-value calculator 108.

In step S507, the processing of steps S203 to S206 described in FIG. 2 (C operation change check processing) is performed.

Since step S508 is similar to the processing of step S207, a description thereof will be omitted.

Next, the flow of FIG. 5B will be described.

In step S509, the calculator 402 transmits an acquisition request for an operation authority to the lens apparatus 100.

In step S510, the calculator 402 determines whether or not a signal indicating that operation authority is available has been received from the lens apparatus 100, i.e., whether or not the operation authority has been acquired. In a case where the calculator 402 determines that the command has been received, it executes the processing of step S511, and in a case where it determines that the command has not been received, it executes the processing of step S509. However, the timeout processing may be provided and the processing may end when the timeout occurs.

In step S511, the calculator 402 transmits the command value of the P operation member 404 to the lens apparatus 100.

In step S512, the calculator 402 transmits the command value of the S operation member 405 to the lens apparatus 100.

In step S513, the calculator 402 transmits the command value of the C operation member 403 to the lens apparatus 100.

This embodiment transmits the command values of the P operation member 404, the S operation member 405, and the C operation member 403 separately, but they may be divided into one or two commands and transmitted simultaneously.

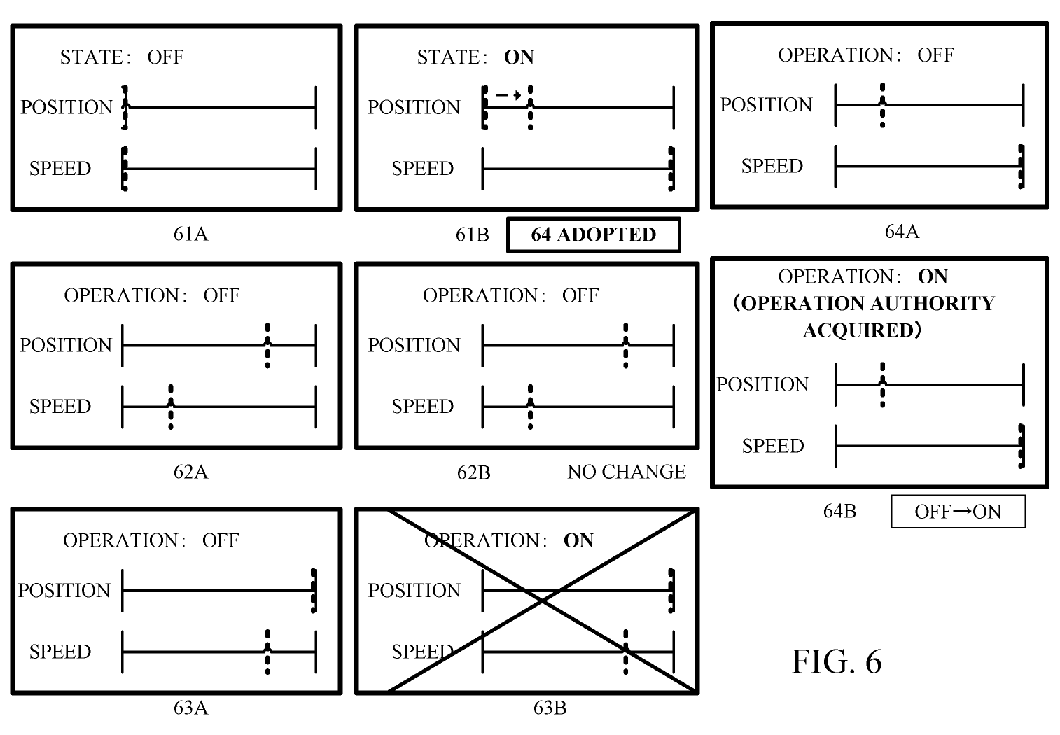

Referring now to 61A, 61B, 62A, 62B, 63A, 63B, 64A, and 64B in FIG. 6, changes in the position and speed of the back-focus lens due to the determination of the command value to be adopted will be illustrated. 61A, 61B, 62A, 62B, 63A, 63B, 64A, and 64B in FIG. 6 are schematic diagrams illustrating the command-value adoption and reflection.

61A and 61B in FIG. 6 illustrate the blurring effect on/off state and the position and speed of the back-focus lens 101. 62A and 62B in FIG. 6 illustrate the command-value state of the lens operation unit in the lens apparatus 100. "Operation" is input from the C operation member 109, "position" from the P operation member 110, and "speed" from the S operation member 111. 63A and 63B in FIG. 6 illustrate the command-value state of the operation apparatus 300. "Operation" is input from the C operation member 302, "position" from the P operation member 303, and "speed" from the S operation member 304. 64A and 64B in FIG. 6 illustrate the state of the command value of the external apparatus 400. "Operation" is input from the C operation member 403, "position" from the P operation member 404, and "speed" from the S operation member 405. A and B in FIG. 6 illustrate at different times, with A illustrating each state at a certain time, while B illustrates a state at a certain time that is more recent than A.

At time 61A in FIG. 6, the blurring effect is turned off and the back-focus lens 101 is stopped at an end position. Assume that the external apparatus 400 has acquired the operation authority at time B. At this time, even if the operation apparatus 300 performs an activation/deactivation operation of the blurring effect as illustrated in 63B in FIG. 6, the operation is not reflected. In a case where operation 64B in FIG. 6 is performed by the external apparatus 400 having the operation authority, for example, the command of external apparatus 400 is adopted according to the flow illustrated in FIGS. 5A and 5B. As a result, the blurring effect is turned on, and in accordance with the command from external apparatus 400, the back-focus lens 101 is driven to the specified target position at a specified speed.

The above configuration can solve problems in situations where it is better not to change the operation unit.

### PATTERN 3

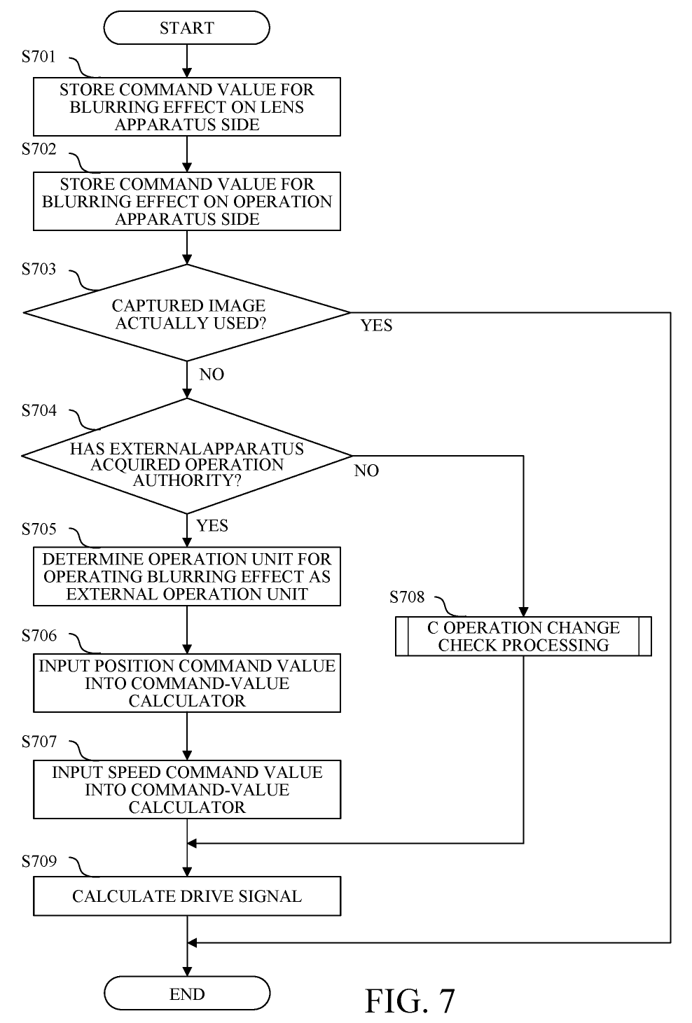

As will be described below, there are situations where a captured image is emphasized and an unintended change to this image is to be avoided. For example, in a live broadcast where the captured image is actually used for television imaging, the focus gradually shifts from the best focus state, or a defocused state gradually moves toward the best focus due to the blurring effect. In a case where the operation is reflected while the blurring effect is being executed, the image may look unnatural, so a measure to avoid this problem may be provided. In this embodiment, the determining unit 107 functions as a determining unit configured to determine whether or not the operation by each of the plurality of operation units can be accepted. An example will be described below with reference to FIGS. 4 and 7. Those elements, which are corresponding elements in patterns 1 and 2, will be designated by the same reference numerals, and a description thereof will be omitted. The block diagram of the imaging system for the following description has the configuration illustrated in FIG. 4, similarly to that in pattern 2.

The processing of selecting the operation unit for controlling the blurring effect and determining the command value to be adopted will be described below. FIG. 7 is a flowchart illustrating a flow of command-value adoption in this embodiment.

The processing of steps S701 to S702 is similar to the processing of steps S201 to S202, respectively, and thus a description thereof will be omitted.

In step S703, the determining unit 107 determines whether the image captured by the lens apparatus 100 (camera apparatus 200) is actually being used. In a case where the determining unit 107 determines that the image is being used, the flow ends, and in a case where it determines that the image is not being used, it executes the processing of step S704. The method of determining whether the image is being used may be, for example, information obtained based on a tally signal or information from other connected devices, and is not limited to this example. In addition, in a case where the captured image is no longer being used, a command may be reflected immediately, or may be reflected from a subsequent operation.

The processing of steps S704 to S709 is similar to the processing of steps S503 to S508, respectively, and thus a description thereof will be omitted.

The above configuration can solve the problem in a situation where a captured image is emphasized and no operation is desired to be reflected.

### PATTERN 4

In a case where the operation unit that has activated the blurring effect and the operation unit that has deactivated the blurring effect are different, the speed at which the focus shifts from the best focus and the speed at which the focus moves from the defocus point to the best focus may differ. In the same situation, they may be the same speed, but the method described in patterns 1 to 3 has the above problem in order to follow the speed command of the operation unit for controlling the blurring effect. Referring now to 91A, 91B, 91C, 92A, 92B, 92C, 93A, 93B, 93C, 94A, 94B, and 94C in FIGS. 4, 8, and 9, a description will be given, as an example method for solving the above problem in a case where one of the blurring effect activation and the blurring effect deactivation is switched to the other of the blurring effect activation and the blurring effect deactivation, of a method of using one speed command instead of the other determined as the operation unit for controlling the blurring effect. Those elements, which are corresponding elements in patterns 1 to 3, will be designated by the same reference numerals, and a description thereof will be omitted. The block diagram of the imaging system for the following description is the configuration illustrated in FIG. 4, similarly to patterns 2 and 3.

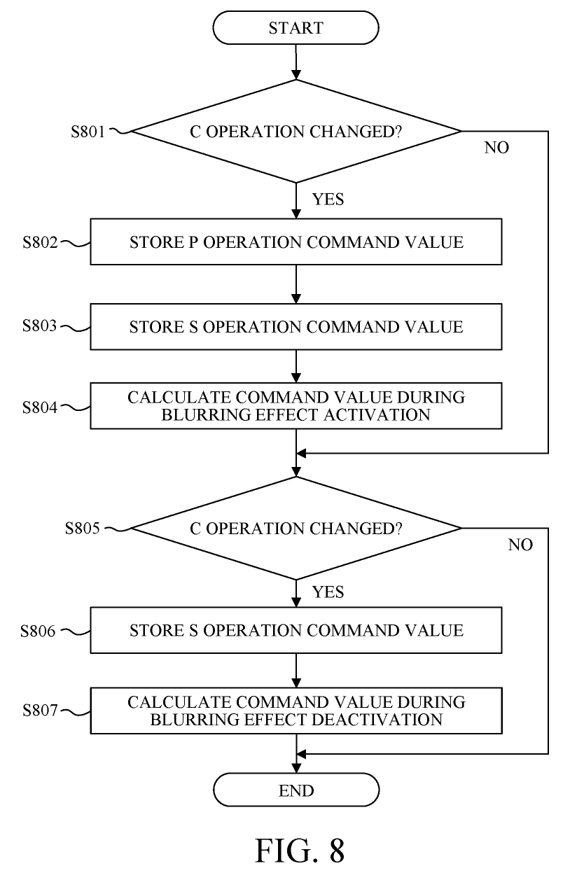

The processing of selecting an operation unit for controlling the blurring effect and determining the command value to be adopted will be described below. FIG. 8 is a flowchart illustrating a flow of command-value adoption in this embodiment.

In step S801, the determining unit 107 determines whether there has been a change in C operation. In a case where the determining unit 107 determines that there has been a change in C operation, it executes the processing of step S802, and in a case where it determines that there has not been a change, it executes the processing of step S805. Here, changes are checked for the C operation member 109, the C operation member 302, and the C operation member 403. It is also assumed that a change from deactivation to activation is confirmed.

In step S802, the calculator 104 stores a P operation command value of the operation unit determined to have changed in step S801.

In step S803, the calculator 402 stores an S operation command value of the operation unit determined to have changed in step S801.

In step S804, the command-value calculator 108 calculates a command value when the blurring effect is activated, based on the position command value and speed command value stored in steps S802 and S803. Here, the calculated command value is converted into an output value, and is output to the back-focus lens drive unit 102.

In step S805, the determining unit 107 determines whether or not there has been a change in the C operation. In a case where the determining unit 107 determines that there has been a change in the C operation, it executes the processing of step S806, and in a case where it determines that there has not been a change, the flow ends. Here, the change from activation to deactivation is confirmed.

In step S806, the calculator 104 stores an S operation command value stored in step S803. What is important here is not to adopt the S operation command value of the operation unit that has been determined to have changed in step S805. If it is assumed that the power is turned off while the blurring effect is turned on, the S operation command value may be stored in a nonvolatile memory (not illustrated).

In step S807, the command-value calculator 108 calculates a command value when the blurring effect is turned off, for moving to the best focus position, based on the speed command value stored in step S806. Here, the calculated command value is converted into an output value and output to the back-focus lens drive unit 102.

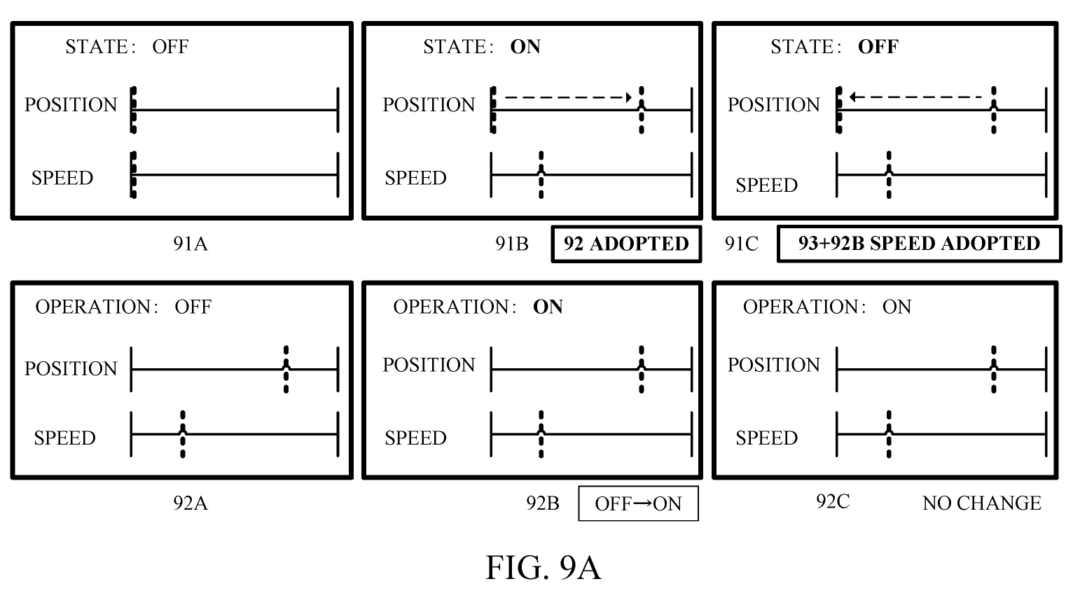

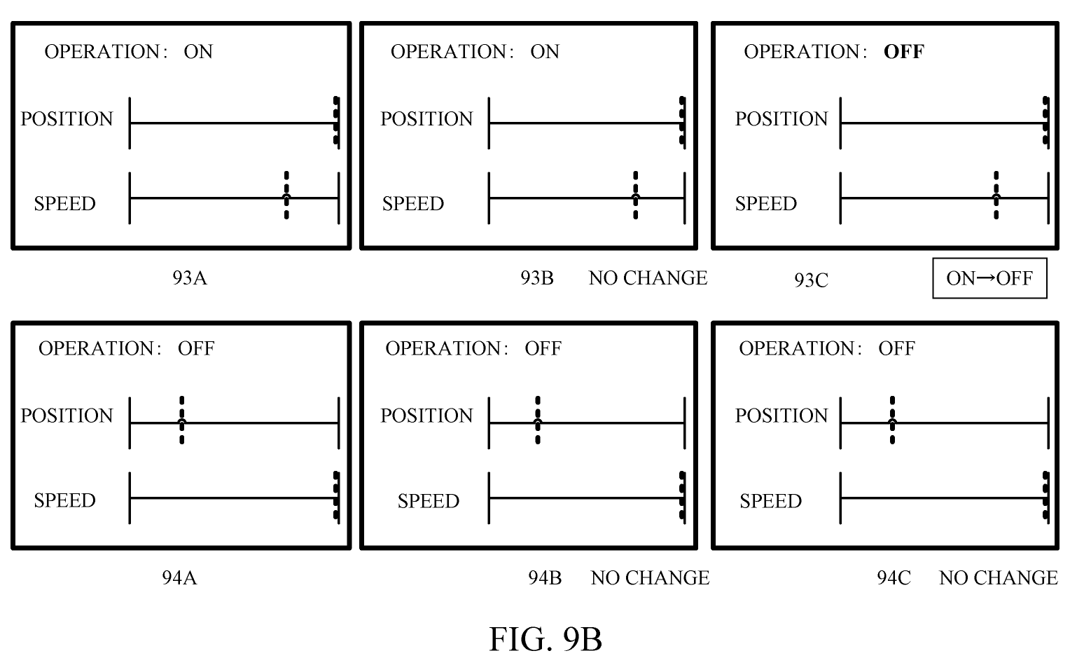

Next, changes in the position and speed of the back-focus lens according to the determination of the command value to be adopted will be illustrated with reference to 91A, 91B, 91C, 92A, 92B, 92C, 93A, 93B, 93C, 94A, 94B, and 94C in FIGS. 9A and 9B. 91A, 91B, 91C, 92A, 92B, 92C, 93A, 93B, 93C, 94A, 94B, and 94C in FIGS. 9A and 9B are schematic diagrams illustrating the command-value adoption and reflection.

91A, 91B, and 91C in FIG. 9A illustrate a blurring effect on/off state and the position and speed of the back-focus lens 101. 92A, 92B, and 92C in FIG. 9A illustrate the command-value state of the lens operation unit in the lens apparatus 100. "Operation" is input from the C operation member 109, "position" from the P operation member 110, and "speed" from the S operation member 111. 93A, 93B, and 93C in FIG. 9B illustrate the command-value state of the operation apparatus 300. "Operation" is input from the C operation member 302, "position" from the P operation member 303, and "speed" from the S operation member 304. 94A, 94B, and 94C in FIG. 9B indicate the command-value state of the external apparatus 400. "Operation" is input from the C operation member 403, "position" from the P operation member 404, and "speed" from the S operation member 405. A, B, and C in FIGS. 9A and 9B indicate states at different times, and while A indicates each state at a certain time, B indicates a state at a certain time after A, and C indicates a state at a certain time after B.

At time 91A in FIG. 9A, the blurring effect is turned off and the back-focus lens 101 is stopped at an end position. In a case where the C operation member 109 of the lens apparatus 100 is operated at time B, for example, as in 92B in FIG. 9A, the command of the lens apparatus 100 is adopted. As a result, the blurring effect is turned on, and the back-focus lens 101 is driven to a specified target position at a specified speed in accordance with the command of the lens apparatus 100. In a case where an operation is performed from the operation apparatus 300 at time C, for example as illustrated in 93C in FIG. 9B, the command to turn off the blurring effect follows the command from the operation apparatus 300. However, for the speed command, the speed when the blurring effect is turned on, that is, the speed command value illustrated in 92B in FIG. 9A, is adopted. As a result, the blurring effect is turned off, and the back-focus lens 101 is driven according to the speed command value when the blurring effect is turned on.

This pattern illustrates an example in which the speed command value when the blurring effect is turned on is applied when the blurring effect is turned off. However, this is not limited to this example, and the speed command value when the blurring effect is turned off may be applied when the blurring effect is turned on (for example, when the blurring effect is turned on when a commercial starts and, conversely, when the blurring effect is turned off after the commercial ends). In addition, it may be determined whether or not to follow the previous speed command value according to the elapsed time since the previous blurring effect on/off switching and the settings.

Instead of the speed command value, the position command value, or both may adopt the previous values.

The above configuration can adopt the operation intended by the user while usability based on the features of the function is considered.

### Second Embodiment

### PATTERN 1

The first embodiment has discussed switching of the operation unit for controlling the blurring effect and command-value adoption. Some lenses driven by the blurring effect include a back-focus lens, which is more sensitive than a focus lens. There has recently been an increase in systems for adjusting the back-focus, which are configured to be operated and driven electrically by remote operation and commands from not only the camera operator but also the VE. In such cases, the same lens is moved to execute two functions with different purposes, and if an operation unit is determined for each function, there is a problem that the user cannot operate it to the intended position. This embodiment illustrates an example for solving the above-mentioned problem.

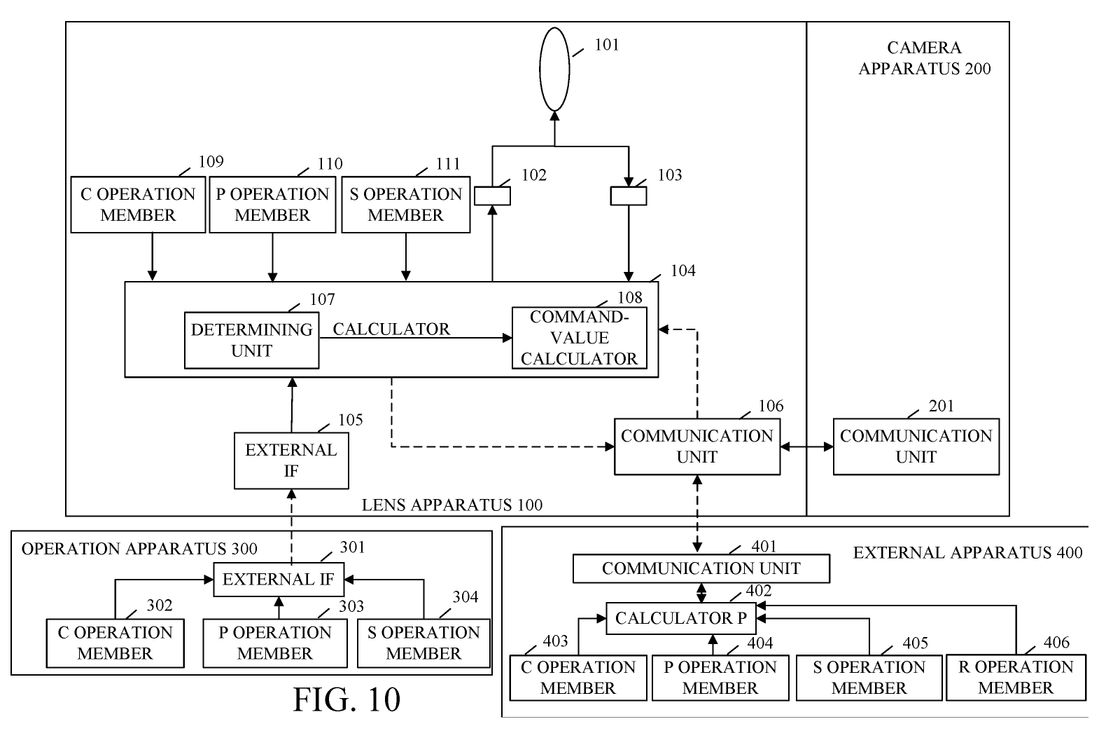

FIG. 10 is a block diagram illustrating an imaging system according to this embodiment. The imaging system according to this embodiment differs from the imaging system of FIG. 4 in the first embodiment in that an R operation member 406 is added to the external apparatus 400.

The R operation member 406 is an operation member for adjusting the back focus. In this embodiment, it is a rotary type volume switch but is not limited to this example. An operation amount of the R operation member 406 is output to the calculator 402.

The calculator 402 converts the input amount of operation for adjusting the back focus into a command value for adjusting the back focus and outputs it to the communication unit 401.

The communication unit 401 transmits the input command value for adjusting the back focus to the lens apparatus 100.

The lens apparatus 100 converts the command value for adjusting the back focus received from the external apparatus 400 into a drive command in the calculator 104. In this embodiment, in adjusting the back focus, this embodiment drives the back-focus lens 101 to be driven with a blurring effect. Therefore, the converted drive command is output to the back-focus lens drive unit 102.

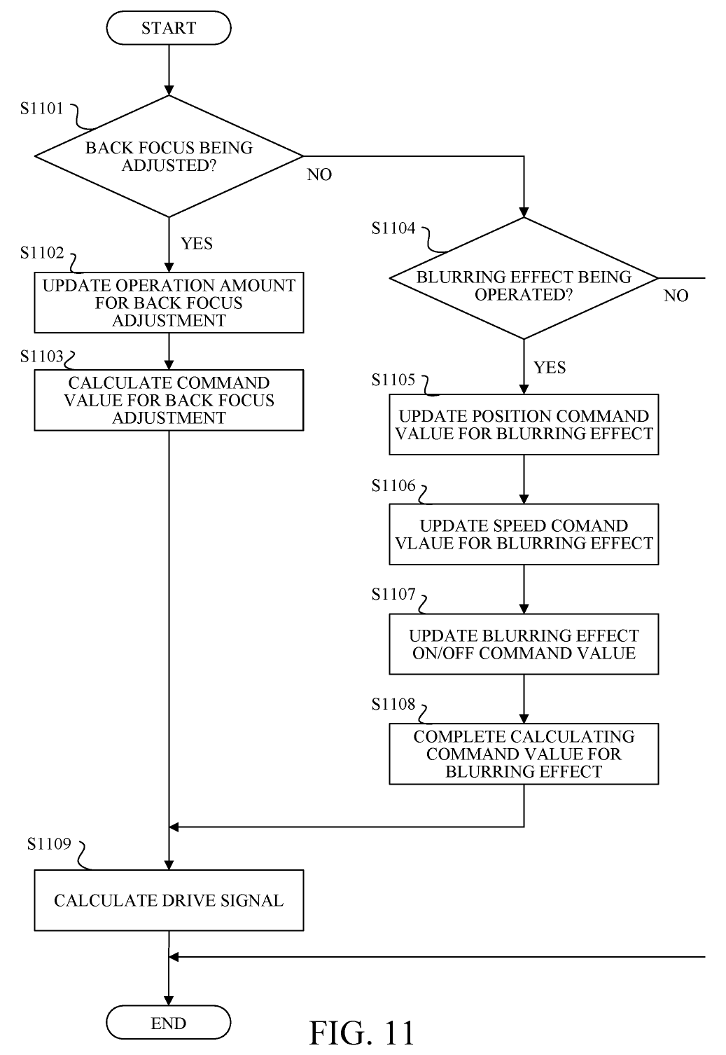

Next follows the processing of selecting an operation unit for controlling the blurring effect and back focus adjustment and determining a command value to be adopted. FIG. 11 is a flowchart illustrating a flow of command-value adoption in this embodiment.

In step S1101, the calculator 104 determines whether or not back focus is being adjusted. The calculator 104 makes this determination based on information such as, for example, whether a command value for adjusting the back focus has been input, whether there has been a change in the command value, and whether it is a back focus adjustment state. In a case where the calculator 104 determines that the back focus is being adjusted, it executes the processing of step S1102, and in a case where it determines that the back focus is not being adjusted, it executes the processing of step S1104.

In step S1102, the calculator 104 updates an operation amount of the back focus adjustment based on the information received from the external apparatus 400.

In step S1103, the calculator 104 calculates a command value for the back focus adjustment.

In step S1104, the calculator 104 determines whether or not the blurring effect is being operated (including whether driving is in progress). In a case where the calculator 104 determines that the blurring effect is being operated, the flow proceeds to step S1105, and otherwise the flow ends.

In step S1105, the calculator 104 updates the position command value for the blurring effect.

In step S1106, the calculator 104 updates the speed command value for the blurring effect.

In step S1107, the calculator 104 updates the blurring effect on/off command value.

In step S1108, the calculator 104 calculates a command value for the blurring effect.

In step S1109, the calculator 104 converts the command value for the back focusing calculated in step S1103 or the command value for the blurring effect calculated in step S1108 into a drive signal. The calculator 104 outputs the converted drive signal to the back-focus lens drive unit 102.

Due to the above configuration, the back focus adjustment and the blurring effect operations are mutually exclusive, the operation intended by the user can be reflected in either function. In this embodiment, the back focus adjustment is operated from the external apparatus 400, but this is not limited to this example, and it may be, for example, from the camera apparatus 200.

### PATTERN 2

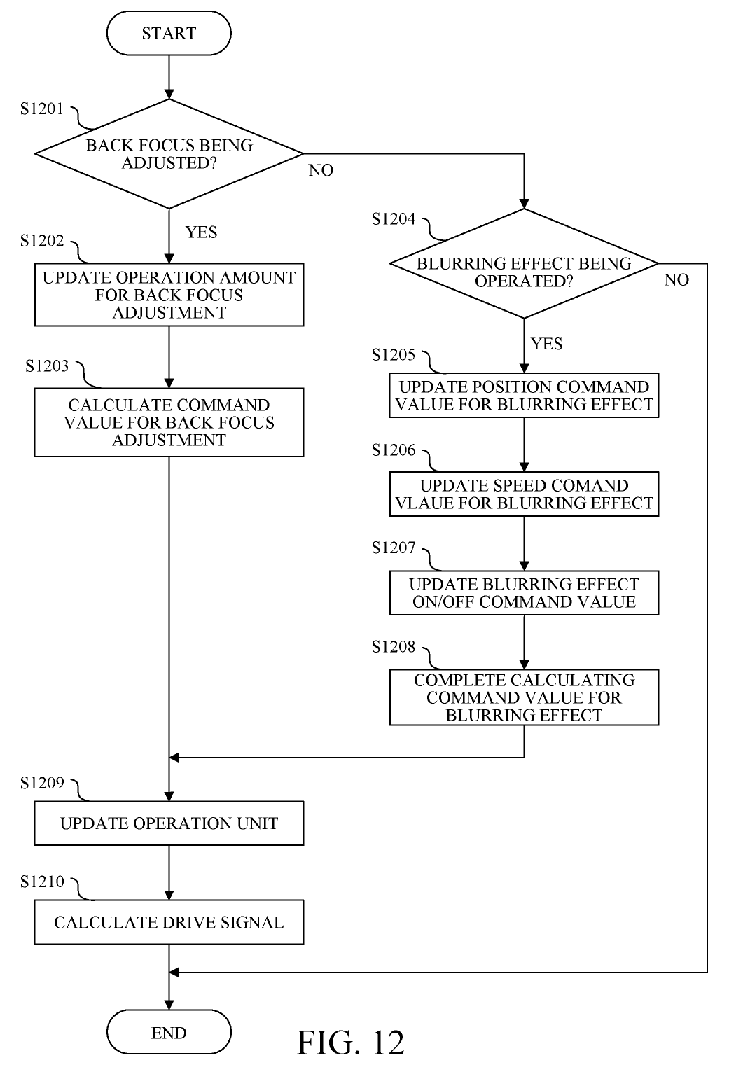

As described below, there is a problem that the user's operation becomes arduous. For example, this is the case when the same person operates the back focus adjustment and the blurring effect. Basically, the back focus adjustment is performed when the camera apparatus 200 and the lens apparatus 100 are connected, and the blurring effect is a function that is controlled during imaging, but the back focus may be finely adjusted according to changes in the surrounding environment and various conditions. In such a case, the operation of determining and operating an operation unit for adjusting the back focus, and then determining an operation unit for controlling the blurring function may be felt to be arduous. Referring now to FIGS. 10 and 12, a description will be given of an example of a method for avoiding the above problem. Those elements, which are corresponding elements in the first embodiment and pattern 1, will be designated by the same reference numerals, and a description thereof will be omitted. The block diagram of the imaging system for the following description has the configuration illustrated in FIG. 10, similarly to pattern 1.

Next follows a description of the processing of selecting an operation unit for controlling the blurring effect and back focus adjustment, and determining a command value to be adopted. FIG. 12 is a flowchart illustrating a flow of command-value adoption in this embodiment.

The processing in steps S1201 to S1208 is similar to the processing of steps S1101 to S1108, respectively, and thus a description thereof will be omitted.

In step S1209, the calculator 104 updates the operation unit for controlling the back focus adjustment and the blurring effect. For example, in a case where the calculator 104 determines in step S1201 that the back focus is being adjusted, the operation unit adopted in steps S1202 and S1203 is determined as the operation unit for controlling the blurring effect. In a case where the calculator 104 determines in step S1204 that the back focus adjustment is not being adjusted and that the blurring effect operation is in progress, the operation unit for turning on and off the blurring effect adopted in step S1207 is determined as the operation unit for controlling the back focus adjustment.

The processing in step S1210 is similar to the processing in step S1109, and thus a description thereof will be omitted.

It is assumed that a certain operation unit may be used only for the back focus adjustment or only for the blurring effect operation, so the above processing may be performed only when the operation unit can be determined, and the operation unit may not be updated otherwise.

The above configuration can improve the efficiency of the user operation and reflect the operation intended by the user.

### Third Embodiment

The first embodiment to the second embodiment illustrates an example in which all operations have an operation member for turning on and off the blurring effect, a position operation member, and a speed operation member. However, depending on the imaging system, it is not rare that some operation members cannot be provided. In some cases, there are systems in which settings can be made only from the setting menu. In such cases, the operation unit and operation amount for controlling the blurring effect are difficult to understand, and the difficulty of operation may increase. In a case where there are a plurality of operators, it becomes necessary to recognize which operation unit performs the blurring effect and which operation unit is in an operable state. Furthermore, the blurring effect described so far has a characteristic that the speed command value is important even for the deactivation operation, and a method that is easier to understand is demanded in a case where a blur amount and speed command are set. This embodiment illustrates an example for solving the above various problems.

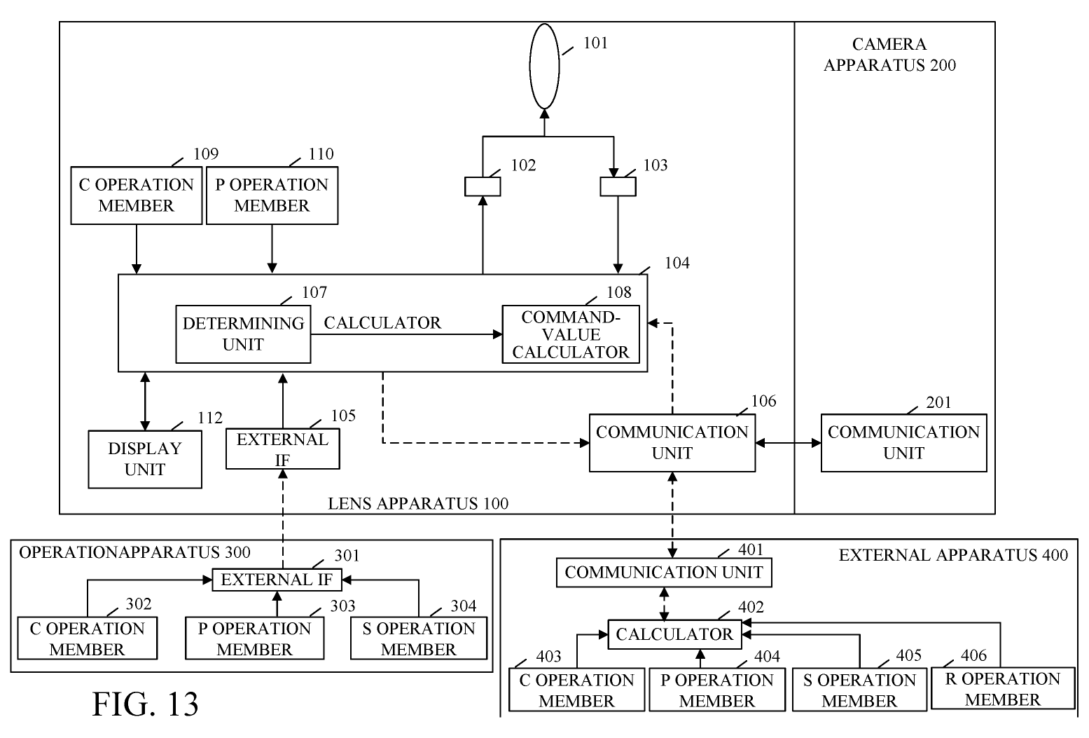

FIG. 13 is a block diagram of an imaging system according to this embodiment. The imaging system according to this embodiment differs from the imaging system in FIG. 10 according to the second embodiment in that the lens apparatus 100 includes a display unit 112 and does not include an S operation member 111. Those elements, which are corresponding elements in the first and second embodiments, will be designated by the same reference numerals, and a description thereof will be omitted.

The lens apparatus 100 does not include the S operation member 111, but instead includes a setting user-interface (UI) (not illustrated), from which the speed of the blurring effect can be set. However, this embodiment is not limited to this example, and the speed may be set using the display unit 112. The calculator 104 calculates a command value for the blurring effect based on the speed setting. The calculator 104 also converts the information on the operation unit determined by the determining unit 107 and the final command-value information into display information, and outputs the converted display information to the display unit 112. That is, the calculator 104 functions as a display control unit configured to control the information to be displayed on the display unit 112. The display unit 112 may be provided in a configuration other than the lens apparatus 100.

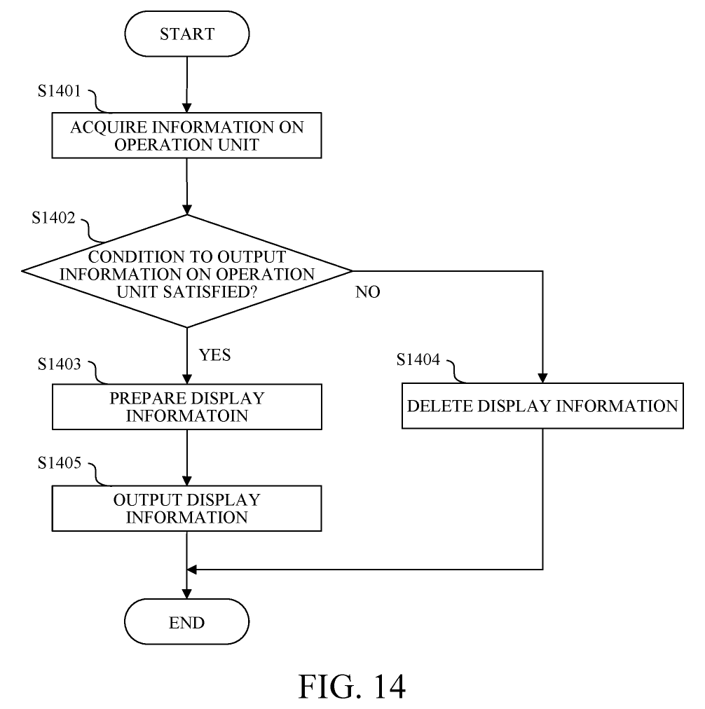

Next follows a description of the processing of outputting display information, which is mainly performed by the calculator 104. FIG. 14 is a flowchart illustrating a flow of displaying command-value information.

In step S1401, the calculator 104 acquires information about the operation unit for controlling the blurring effect.

In step S1402, the calculator 104 determines whether or not the condition for outputting information about the operation unit for controlling the blurring effect to the display unit 112 is satisfied. In a case where the calculator 104 determines that the condition is satisfied, it executes the processing of step S1403, and in a case where it determines that the condition is not satisfied, it executes the processing of step S1404. In this embodiment, it is assumed that the condition is satisfied in a case where a plurality of operators can operate the blurring effect and the blurring effect is turned on.

In step S1403, the calculator 104 creates display information to be displayed on the display unit 112 based on the information about the operation unit acquired in step S1401.

In step S1404, the calculator 104 deletes the display information to be displayed on the display unit 112.

In step S1405, the calculator 104 outputs the display information created in step S1403 or step S1404 to the display unit 112.

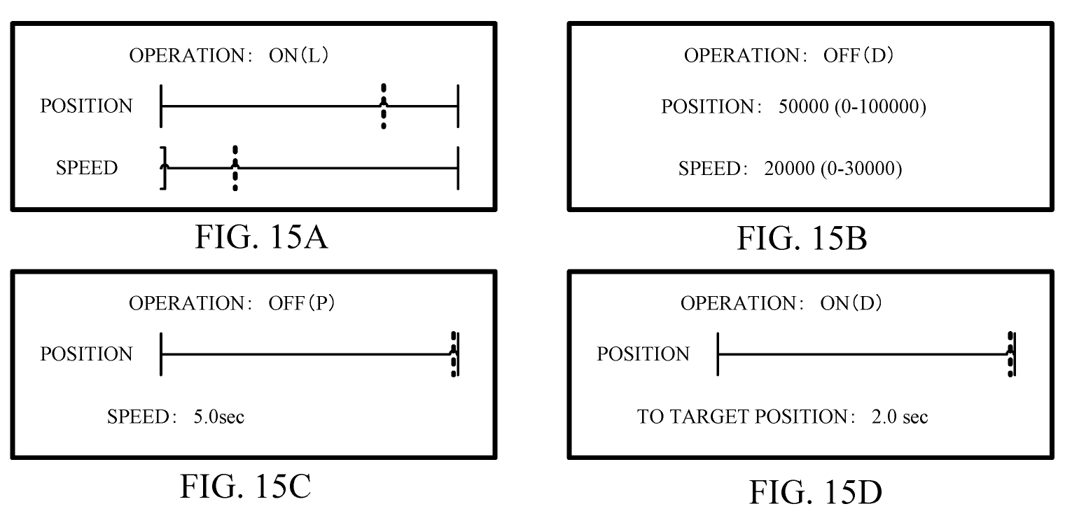

A description will now be given of an example of the command-value display for the blurring effect output to the display unit 112. FIG. 15 illustrates an example of the command-value display.

FIG. 15A displays the final command-value state (activation/deactivation, position command, speed command) and information on which operation unit controls the blurring effect. (L) in the figure indicates the lens apparatus 100. The current state can be viewable, for example, by a remote operator.

A description will now be given of other patterns with reference to FIGS. 15B, 15C, and FIG. 15D. FIG. 15B displays a position command value and speed command value as numerical values. This is effective in cases where it is easier to set numerical values, such as when setting while checking the display unit 112. Thus, it is effective to display when an operation amount is being changed, not limited to cases where the operation unit is used to control the blurring effect. (D) in the figure indicates that the operation apparatus 300 is an operation unit for controlling the blurring effect.

FIG. 15C illustrates a position command value as a diagram, and a speed command value as the time to the target position. A characteristic of the blur function is that a target position in shifting the focus does not often require high accuracy. Since the number of seconds after which the blurring effect operation ends is important information for the next imaging operation, such a display is also effective. (P) in the figure indicates that the external apparatus 400 is an operation unit for controlling the blurring effect.

FIG. 15D illustrates an example of the display during operation when the blurring effect is turned on by operating the operation apparatus 300, as compared to FIG. 15C. During the operation, the display is updated to count down the time to the target position.

The above description illustrates one display example, but is not limited to this example. For example, in a case where there is no speed operation member, only the speed setting may be displayed. Even if the operation member is easy to operate, confirmation may be difficult. Including such a case, the display may be made only when necessary by the user. Since constant display may be bothersome, the display may be switched according to the action or operation, such as display being stopped when the action is completed. A remote operator may be displayed, or a list of all the statuses of operators who can operate the lens apparatus may be displayed. They may be switchable by settings.

### Other Embodiments

Embodiment(s) of the disclosure can also be realized by a computer of a system or apparatus that reads out and executes computer executable commands (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable commands from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable commands. The computer executable commands may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment according to the disclosure can provide a lens apparatus that can move a target to a desired position even when each of a plurality of operators performs a plurality of types of operations.

This application claims the benefit of Japanese Patent Application No. 2024-173124, which was filed on October 2, 2024, and which is hereby incorporated by reference herein in its entirety.

What is claimed is:

1. A lens apparatus comprising:
an optical member movable according to control by each of a plurality of operation units;
one or more memories storing commands; and
one or more processors that, upon execution of the commands, operate to:
determine a first operation unit for moving the optical member from the plurality of operation units, and
move the optical member according to information on at least one of a target position and a speed of the optical member set by the first operation unit,
wherein the lens apparatus includes a predetermined function, and
wherein the one or more processors operate to determine an operation unit which transmits a signal regarding activation and deactivation of the predetermined function at an earliest timing among the plurality of operation units, as the first operation unit,
wherein each of the plurality of operation units includes:
a first operation member configured to switch the activation and the deactivation of the predetermined function,
a second operation member configured to change the target position, and
a third operation member configured to change the speed.

2. The lens apparatus according to claim 1, wherein the predetermined function includes a function for changing a focus of the captured image by moving the optical member.

3. The lens apparatus according to claim 1, wherein in a case where the first operation unit determined by the one or more processors is different in a case where the predetermined function is switched from one of an activated state and a deactivated state to another of the activated state and the deactivated state, the optical member moves according to information regarding at least one of the target position and speed of the optical member in a case where the predetermined function is in the one of the activated state and the deactivated state.

4. The lens apparatus according to claim 1, wherein in a case where the one or more processors transmit a signal to the first operation unit indicating that the first operation unit has been determined, the one or more processors operate to move the optical member according to only control from the first operation unit.

5. The lens apparatus according to claim 1, wherein the one or more processors operate to determine whether or not the control by each of the plurality of operation units can be accepted, and
wherein in a case where the one or more processors determine that the control by each of the plurality of operation units cannot be accepted, the optical member does not move according to the control by each of the plurality of operation units after the one or more processors have determined whether the control can be accepted.

6. The lens apparatus according to claim 5, wherein in a case where an image captured using the lens apparatus is used, the one or more processors operate to determine that the control by each of the plurality of operation units cannot be accepted, and
wherein in a case where the image is not used, the one or more processors operate to determine that the control can be accepted.

7. The lens apparatus according to claim 1, wherein the lens apparatus has a first function for moving the optical member and a second function for moving the optical member, and
wherein in a case where one of the first function and the second function is being executed, another of the first function and the second function is not executed.

8. The lens apparatus according to claim 7, wherein the first function is a function of changing a focus of a captured image by moving the optical member, and
wherein the second function is a function of adjusting a back focus by moving the optical member.

9. The lens apparatus according to claim 7, wherein the first function and the second function are executed according to an operation of the first operation unit.

10. The lens apparatus according to claim 1, wherein the one or more processors operate to cause a display unit to display information on the first operation unit and information on at least one of a position and the speed of the optical member.

11. The lens apparatus according to claim 1, wherein at least one of the target position and the speed is changeable.

12. The lens apparatus according to claim 1, wherein the optical member is a lens unit that is movable along an optical axis in the lens apparatus.

13. An image pickup apparatus comprising:
a lens apparatus;
an imaging element;
wherein the lens apparatus includes:
an optical member movable according to control by each of a plurality of operation units;
one or more memories storing commands; and
one or more processors that, upon execution of the commands, operate to:
determine a first operation unit for moving the optical member from the plurality of operation units, and
move the optical member according to information on at least one of a target position and a speed of the optical member set by the first operation unit,
wherein the lens apparatus includes a predetermined function, and
wherein the one or more processors operate to determine an operation unit which transmits a signal regarding activation and deactivation of the predetermined function at an earliest timing among the plurality of operation units, as the first operation unit,
wherein each of the plurality of operation units includes:
a first operation member configured to switch the activation and the deactivation of the predetermined function,
a second operation member configured to change the target position, and
a third operation member configured to change the speed.

14. An imaging system comprising:
a lens apparatus,
an image pickup apparatus including an image sensor, and
an external apparatus that is at least one of a plurality of operation units,
wherein the lens apparatus includes:
an optical member movable according to control by each of a plurality of operation units;
one or more memories storing commands; and
one or more processors that, upon execution of the commands, operate to:
determine a first operation unit for moving the optical member from the plurality of operation units, and
move the optical member according to information on at least one of a target position and a speed of the optical member set by the first operation unit,
wherein the lens apparatus includes a predetermined function, and
wherein the one or more processors operate to determine an operation unit which transmits a signal regarding activation and deactivation of the predetermined function at an earliest timing among the plurality of operation units, as the first operation unit,
wherein each of the plurality of operation units includes:
a first operation member configured to switch the activation and the deactivation of the predetermined function,
a second operation member configured to change the target position, and
a third operation member configured to change the speed.
